(19) United States
(12) Patent Application Publication
(10) Pub. No.: US 2004/0028168 A1
(43) Pub. Date: Feb. 12, 2004

(54) Method and device for checking and examining the inside surface of nuclear and thermonuclear assemblies

(76) Inventors: Alexandr Leonidovich Suvorov, Moscow (RU); Boris Albertovich Loginov, Moscow (RU); Oleg Nikolaevich Makeev, Moscow (RU)

Correspondence Address: BURNS DOANE SWECKER & MATHIS L L P, POST OFFICE BOX 1404, ALEXANDRIA, VA, 22313-1404, US

(21) Appl. No.: 10/332,460

(22) PCT Filed: Jul. 25, 2001
(86) PCT No.: PCT/RU01/00309

(30) Foreign Application Priority Data
Jul. 27, 2000 (RU) 2000119943

(51) Int. Cl. G21C 19/00

(52) U.S. Cl. 376/260

(57) ABSTRACT

The invention relates to nuclear engineering and more particularly to a method and apparatus for inspecting and examining a surface inside experimental channels of nuclear and thermonuclear plants, providing examination of the surface both in the course of and after irradiation, the surface being examined in different operation modes of a probe scanning microscope by selecting a probe and a respective mode; the obtained images of different characteristics of the surface are analyzed to judge the degree and dynamics of irradiation effect on the examined surface from the analysis results, wherein the probe scanning microscope comprises a computer with a control console, and a measuring head of the probe scanning microscope, the measuring head including a cylinder housing (1) with dogs (4), a scanning unit, an electronics unit (3), a data path (2), a video camera (5), lights (6) and a retaining mechanism.

### FIELD OF THE INVENTION

The present invention relates to nuclear engineering and more particularly to inspecting the state of the interior surfaces of nuclear and thermonuclear plants, other installations and structures having internal cavities that imply the presence of ionizing radiation (charged particle accelerators, etc.), as well as to examination and analysis of the materials that have been or are being exposed to radiation.

### BACKGROUND OF THE INVENTION

A method for examining specimens cut from the interior surface of reactor vessels is disclosed by Platonov P. A. et al. The properties of WWER-440 type reactor pressure vessels from operated units. Nuclear Engineering and Design, 195 (2000) 137-142. The method involves cutting small specimens, templates, from the interior surface of reactor vessel walls. The templates are then removed from the reactor for examining their mechanical properties. Based on the examination results, the degree of radiation embrittlement of the reactor vessel material is assessed. The method allows both the specimen surface and structure to be examined in detail, however, only outside the reactor. This prevents obtaining information on the dynamics of surface change (degradation) during the reactor operation. In addition, the method requires that the reactor vessel be partly destroyed.

A method for examining a surface of specimens irradiated in a nuclear reactor channel is described by M. A. Kozodaev et al. Scanning tunnel microscope analysis of surface structure of graphite exposed to pulsed irradiation by fission fragments. PSTF, 2000, vol.26, issue 10, pp. 1 to 8. The method involves the following steps. Specimens of different materials are irradiated in a nuclear plant channel. The specimen surfaces are then examined by a sounding scanning microscope. The obtained topographic images are analyzed to determine the degree of irradiation effect on the material tested. Surface degradation of a material after the exposure can be judged from the analysis results. A problem with the method is that the irradiated specimens must be “seasoned” for a long time to reach the radiation level safe for the investigator. Furthermore, the method prevents judging the dynamics of changes on the specimen surfaces in the course of exposure, since all the examinations are carried out after the exposure and outside the plant.

Blackford, Dan, Jerico, High-Stability Scanning Tunnel Microscope Based on Bimorph Cells. Research Instruments, vol.8, 1987, pp.3-13, discloses an apparatus for examining a surface, comprising a computer with a control console, a measuring head of a probe scanning microscope, the measuring head including a housing, a scanning unit with a probe and a probe holder, a rough delivery device and electronics unit. The apparatus is however restricted to a single method of examining a surface, a scanning tunnel microscopy mode, and comprises a quite sophisticated, tripod-shaped structure of the scanner. The apparatus structure prohibits incorporation of the apparatus in various plants and, hence, examination of the interior surfaces of nuclear and thermonuclear plants.

### SUMMARY OF THE INVENTION

The object of the present invention is to provide a method and apparatus having extended capabilities and enabling a real-time inspection of the state of the interior surfaces of nuclear and thermonuclear plants, as well as to extend the range of techniques for studying radiation resistance of various materials, in particular, in the course of irradiation in experimental channels of the plants.

The object of the invention is attained by examining a surface both in the course of and after irradiation, the surface being examined in different operation modes of a probe scanning microscope by selecting a probe and a respective mode, analyzing the obtained images of different characteristics of the surface, and judging, based on analysis results, the degree and dynamics of irradiation effect on the examined surface.

Distribution of friction forces over the examined surface is preferably determined by scanning by a common cantilever across the cantilever width.

Magnetization of the examined surface is preferably determined by interaction of a magnetized probe with the surface.

Distribution of electrostatic charge over the examined surface is preferably determined by interaction of electric charge at a cantilever with the surface.

Distribution of temperature field of the examined surface and a thermal conductance map are preferably determined by interaction of a thermocouple on the cantilever with the surface.

The above object is further attained in an apparatus according to the invention comprising a computer with a control console, and a measuring head of a probe scanning microscope, wherein the measuring head includes a housing, a rough delivery device, electronics unit and a scanning unit including a scanner, a probe holder and a probe, the housing having dogs, the measuring head being equipped with a retaining device, and the rough delivery device having a limit stop to prevent the scanner from possible collision with the examined surface, and the electronics unit having a protective shield for shielding against electromagnetic and other radiation.

The apparatus preferably comprises a video camera with lights for visual observation of the examined surface.

### BRIEF DESCRIPTION OF THE DRAWINGS

The present invention will become more apparent from the detailed description set forth below when taken in conjunction with the drawings wherein:

FIG. 1 is a general view of an apparatus with a computer and a measuring head located in an experimental channel;

FIG. 2 is a general view of a measuring head for the case of examining walls of an experimental channel;

FIG. 3 is a plan view of the measuring head;

FIG. 4 is a measuring head for the case of examining specimens in an experimental channel;

FIG. 5 is a measuring head for the case of examining specimens in a hot chamber;

FIG. 6 is a measuring head for the case of examining surfaces of internal cavities in plants.

### DETAILED DESCRIPTION OF THE INVENTION

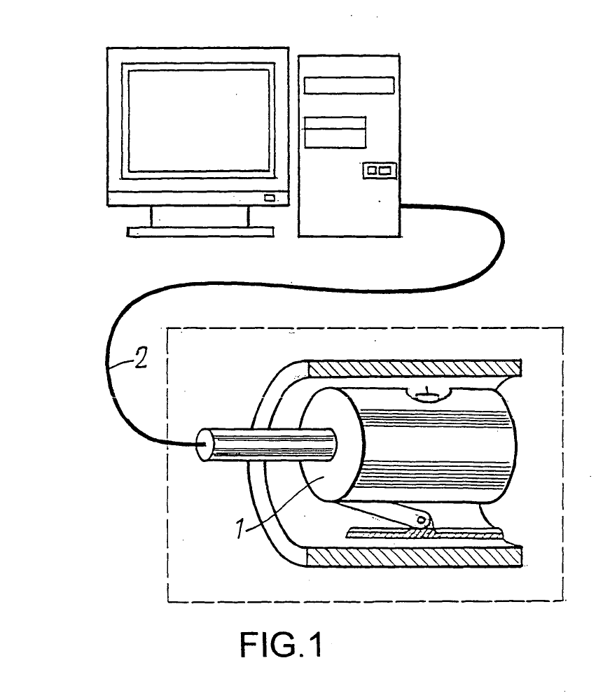

Referring to the drawings, FIG. 1 shows an apparatus for inspecting and examining a surface inside experimental channels in nuclear, thermonuclear and other plants, comprising a probe scanning microscope including a computer with a control console, a measuring head of the probe scanning microscope, the measuring head including a cylinder housing 1 and a data path 2.

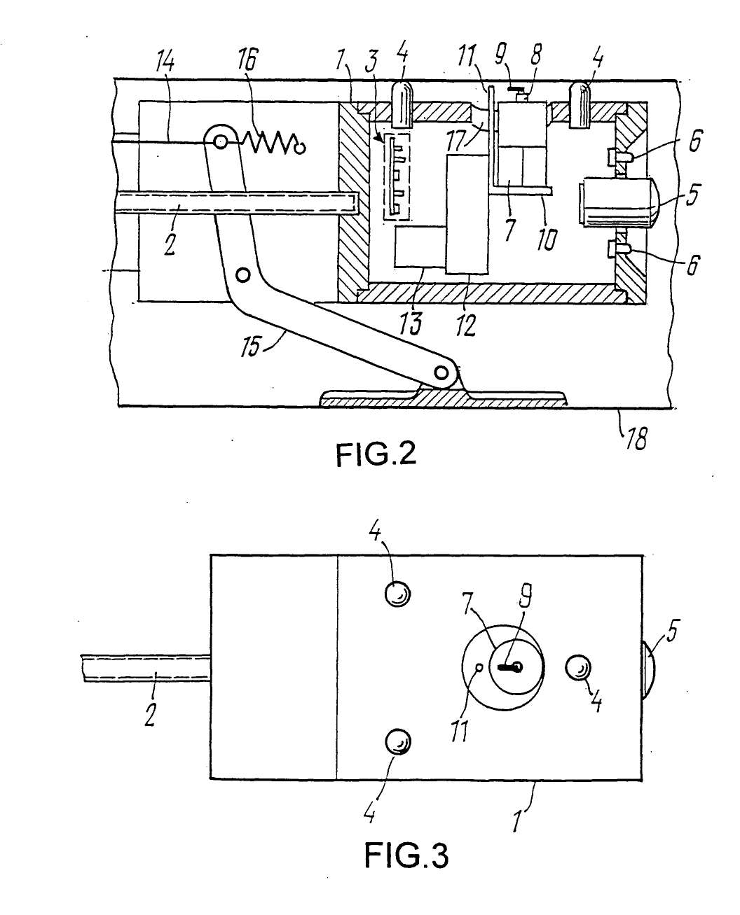

FIG. 2 shows a general view of a measuring head for the case of examining of experimental channel walls, comprising a scanning unit coupled to a rough delivery device, an electronics unit 3, a cylinder housing 1 provided with dogs 4, a video camera 5, lights 6 and a retaining mechanism.

The scanning unit includes a scanner 7 with a probe holder 8 and a probe 9.

The scanner comprises a hollow piezoelectric cylinder capable of high-precision (accurate to about Angstrom unit) movement of the probe along three coordinates when appropriate electric pulses are fed thereto. The movement range is of the order of micrometer units.

The rough delivery device includes a base 10 with a limit stop 11, a reducer 12 and a stepping motor 13. The base is kinematically coupled to the stepping motor through the reducer. The limit stop 11 protects the scanner against possible collision with the surface being examined. Such a situation may arise due to failure, by some reason, to detect a signal of interaction between the probe and the surface when the scanner with the probe is fed towards the surface being examined. In this case the control system, erroneously assuming that the surface is still far, will not issue a signal to interrupt the movement. As the result, the scanner will unavoidably collide with the examined surface. The reducer converts rotational movement of the motor into translation of the base which moves the scanning unit mounted thereon.

FIG. 3 shows a plan view of the measuring head.

To operate in a plant experimental channel, the measuring head is further equipped with a retaining mechanism consisting of a cable 14, a spacer 15 and a spring 16.

The data path, which is laid e.g. in a rod or manipulator, includes supply cables and measuring head control cables. The data path and the electronics unit have protective shields for shielding against magnetic pickup effects and other kinds of radiation inside the plant.

The video camera provides visual observation of the examined region. Having a viewing angle of about 180°, the video camera allows a preliminary observation of the examined region for selecting an optimal site. Illumination is provided by the lights.

Operation of the measuring head is generally controlled by the computer and the control console.

The apparatus can operate in various modes, in particular: scanning tunnel microscopy (STM) mode and, as a variant, scanning tunnel spectroscopy (STS) mode; atomic force microscopy (AFM) mode; lateral force microscopy (LFM) mode; magnetic force microscopy (MFM) mode; electrostatic force microscopy (EFM) mode, and temperature force microscopy (TFM) mode.

In the STM (STS) mode, a sharp needle is preliminary placed in the probe holder, while in the remaining modes an appropriate cantilever is used. In the AFM and LFM modes any cantilever can be used; in the MFM mode a cantilever with a magnetized point is used; in the EFM mode a cantilever with a conducting bracket is used; in the TFM mode a cantilever with a thermocouple formed on its point is used.

A method for inspecting and examining a surface inside nuclear, thermonuclear and other plants is accomplished in the following manner. Prior to loading the measurement head inside the plant, an operation mode should be chosen. Choice of a mode depends on a required information about the surface. The STM mode provides a high-resolution (up to atomic level) topographic image of the surface being examined, and a current-voltage characteristic (CVC) of a tunnel gap (in the STS mode), this mode being restricted to the presence of surface conductance; the AFM mode also provides a topographic image of the examined surface, but the mode is independent of surface conductance; the LFM mode provides a map image of friction forces over the surface; the MFM mode provides a map of surface magnetization; the EFM mode provides an image of electrostatic charge distribution over the surface; the TFM mode provides an image of surface temperature field and a thermal conductance map.

After loading into the plant, the measuring head is conveyed by a manipulator or another transport means to the intended examination region and fixed there. Rigid fixation is necessary to prevent vibrations of the probe relative to the examined surface during scanning. The vibrations may significantly impair quality of the results obtained.

To operate in the experimental channel, the measuring head is equipped with a retaining device. Fixation is performed by a spacer that is pressed by cable a against the housing of the measuring head during transportation thereof so that to provide unhampered movement along the channel. Once the transportation is terminated, the cable releases the retaining spring that urges the spacer against the channel wall. By this means the measuring head with a window 17 of the probe facing the examined surface happens to be tightly pressed against a channel wall by three dogs 4.

In the case of examining the interior surface of the experimental channel 18 in FIG. 2 or another tubular structure, the measuring head further operates as follows. By the coarse delivery device, the probe (the needle in the case of the STM (STS) mode, or a respective cantilever in the case of the other modes) is delivered to the examined surface until a signal of interaction between the probe and the surface is received. In the STM (STS) mode, the signal is a predetermined value of the magnitude of tunnel current between the needle point and the examined surface. In the other modes, the signal is a predetermined value defining interaction between the cantilever point and the examined surface. Components of this signal include intermolecular interaction plus interaction inherent in each of the modes. In the MFM mode, this is interaction between the magnetized probe and the surface. In the EFM mode, this is interaction between electric charge on the cantilever and the surface. In the TFM mode, this is interaction between the thermocouple and the surface. In the AFM and LFM modes, this is intermolecular interaction only.

Then the operator chooses scanning parameters: resolution, field size, frame (scan) read-out frequency, that are required to perform the desired studies. The scanning parameters are selected based on the tasks set. However, the general requirement of the modes of scanning in high radiation fields is to employ high-speed scanning with a frame (scan) read-out frequency of 1 to 10 frames per second. This is dictated by short life of the measuring head electronics in such conditions, which may be as short as few minutes, depending on the radiation intensity. That is why the idea of such measurements is to obtain, in a minimum time, a maximum amount of information for further analysis. Several similar measuring heads are provided to carry out the studies. Therefore, when a measuring head fails under the radiation impact, it will be replaced by a new one.

The process of scanning and information transmission to the computer is then carried out similarly to scanning by probe scanning microscopes in the usual fashion. The scanner provides scanning motions of the probe along the frame. By variation of the value of interaction between the probe and the surface, the control system monitors e.g. relief changes and properly adjusts the probe position relative to the surface by moving the probe by the scanner and thereby restoring the value of probe interaction with the surface to a predetermined level.

In the STM mode, a topography of the conducting surface is recovered from the probe movements (vertical and horizontal). In the AFM mode, a surface topography of any solid body is recovered. In the STS mode, a voltage (e.g. from −2V to +2V) applied to the surface at a fixed distance between the needle and the surface is scanned, and the voltage-current characteristic obtained for each scan point provides an electronic structure image of the surface. In the LFM mode, the scanner scans across the cantilever width, rather than along its length. It means that when following the surface relief, the cantilever bends not in the longitudinal direction, but in the lateral one. Therefore, a map image of friction forces over the surface is reproduced. In the MFM mode, a surface magnetization image is obtained by scanning the surface by a magnetized cantilever. In the EFM mode, voltage is fed into the cantilever arm, and image of electric charge distribution over the surface is obtained in scanning. In the TFM mode, a signal received from a thermocouple when scanning provides temperature distribution over the surface and a thermal conductance map.

The obtained data is transmitted through the electronics unit and data path to the computer, rendered as image frames, accumulated, processed by software and analyzed. From the analysis results, the conclusion can be drawn regarding the degree of radiation impact on the examined surface leading to changes and degradation of the surface, in particular regarding the dynamics of such changes in the course of irradiation. For the plants that are not associated with radiation, the conclusion can be drawn regarding degradation of the surface in service of the plants.

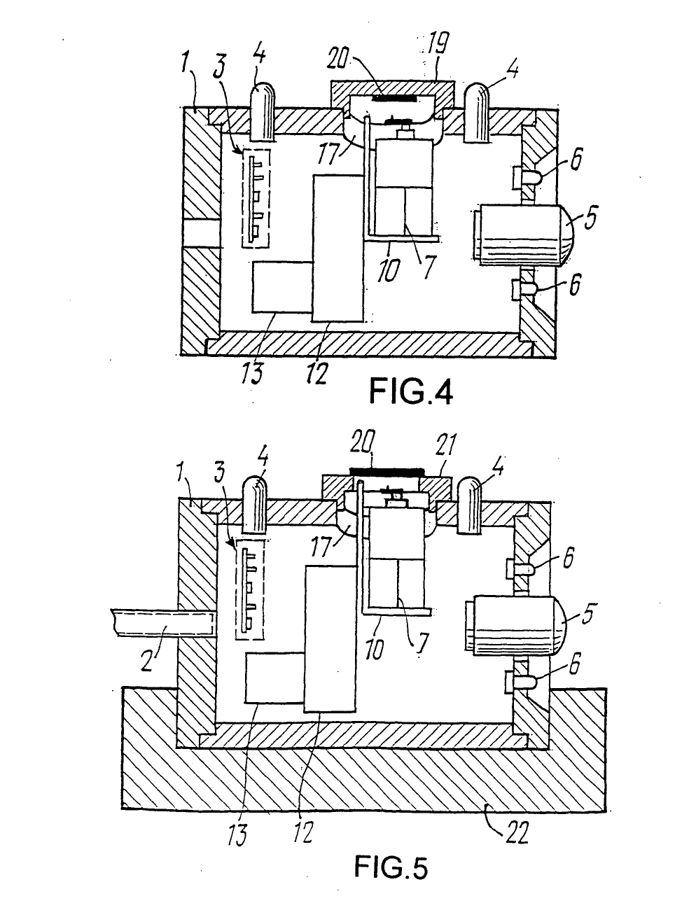

FIG. 4 shows a measuring head for the case of examining the dynamics of surface change (degradation) process of various materials (specimens) under the radiation effect. Prior to loading into a nuclear or thermonuclear plant experimental channel, the probe window is closed by a plug 19 with a specimen 20 to be tested, attached to the internal side of the plug. The procedure of loading the measuring head, its fixation, delivery of the probe to the specimen and scanning procedure are then performed as described before.

FIG. 5 shows a measuring head for the case of examining the surface of irradiated specimens having a considerable radiation level (e.g. specimens cut from the reactor walls) in a hot chamber. The measuring head is placed into the hot chamber in front of the viewing window. The probe window is preliminary closed by the plug 21 which serves as a table for examining the specimens that are accessed by the probe through opening in the plug. The measuring head as such is mounted with the window up on a retaining base 22.

The irradiated specimen is placed, by manipulators, with the examined surface down on the plug, opposite the probe. The further steps, such as delivery of the probe to the specimen surface and scanning as such, are performed as described before.

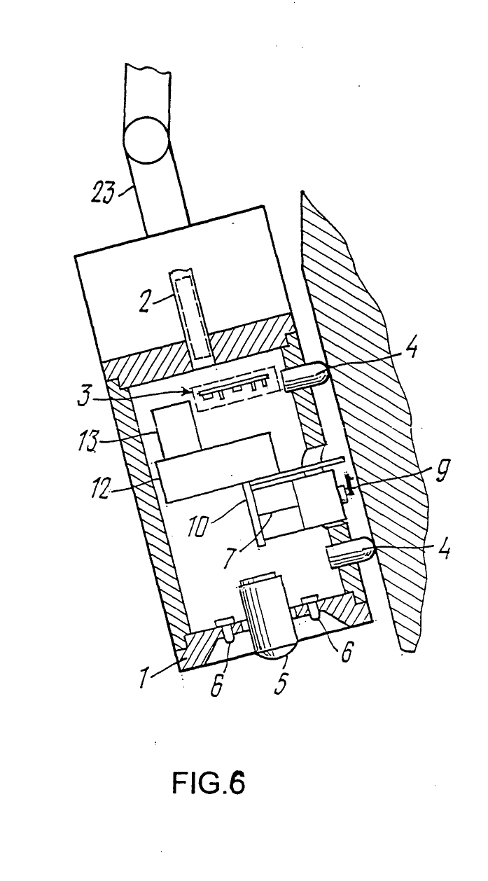

FIG. 6 shows a measuring head for the case of examining cavities inside nuclear, thermonuclear and other plants, wherein the head is fixed relative to the examined surface by a method specific to a manipulator 23 or transport means.

Choice of a region to be examined inside various plants is restricted only by ability of a manipulator (or some other transport means) to deliver the measuring head into a cavity and fix the same at the place of examination. State of environment is also of importance: the measuring head is capable of operating at a temperature no higher than 200° C. in vacuum, air, inert gas environment.

### INDUSTRIAL APPLICABILITY

The present invention makes it possible to carry out complex analysis of the state of surfaces of internal cavities in nuclear, thermonuclear and other plants that imply the presence of ionizing radiation (charged particle accelerators, etc.). Information can be obtained about the dynamics of degradation of such surfaces under irradiation impact, including hard-to-reach places. The obtained information is extremely detailed since the apparatus exhibits, in the limit, atomic resolution. Capabilities of the present invention allow its use as a component of a real-time thermonuclear equipment diagnosis system, owing to the possibility of real-time monitoring of any changes in the surface structure, formation of flaws, bulging, crack nuclei, character of sputtering, etc. On the basis of this information, personnel may timely interfere in the operation process of the plant as the need arises.

A doubtless advantage of the invention is the possibility of its use for examining a wide range of structural materials: metals and alloys, steels, semiconductors and insulators, superconductors, dielectrics, carbon materials etc. The invention may be quite effectively used to examine effects of various radiation types on specimens of different materials placed in nuclear and thermonuclear plant channels. In this case the specimen surfaces can be inspected both in the course of and after the irradiation, as well as in the postradiation annealing process, this being done both inside and outside the plant—in hot chambers of specialized laboratories. An advantage of the use of the apparatus according to the invention is the fact that investigations in the regions with a high radiation level are remotely performed. Taking into account that the most expensive components of the apparatus (computer, power supply units, etc.) are outside the radiation zone and only the measuring head needs to be periodically replaced, the apparatus as a whole appears to be quite cost-effective, especially in the light of unique possibilities provided by its use. And finally, it should be particularly emphasized that the in-reactor examination and inspection methods implemented by an apparatus in accordance with the invention are nondestructive which fact is also advantageous.

What is claimed is:

1. A method for inspecting and examining a surface inside experimental channels of nuclear and thermonuclear plants, using a probe scanning microscope, characterized by the steps of:
examining the surface both in the course of and after irradiation, said surface being examined in different operation modes of the probe scanning microscope by selecting a probe and a respective mode;
analyzing images of the obtained different characteristics of the surface, and
judging, from the analysis results, the degree and dynamics of irradiation effect on the examined surface.

2. The method as set forth in claim 1, wherein distribution of friction forces over the examined surface is determined by scanning by a common cantilever across the cantilever width.

3. The method as set forth in claim 1, wherein magnetization of the examined surface is determined by interaction of a magnetized probe with the surface.

4. The method as set forth in claim 1, wherein distribution of electrostatic charge over the examined surface is determined by interaction of electric charge at a cantilever with the surface.

5. The method as set forth in claim 1, wherein distribution of temperature field of the examined surface and a thermal conductance map are determined by interaction of a thermocouple on the cantilever with the surface.

6. An apparatus for inspecting and examining a surface inside experimental channels of nuclear and thermonuclear plants, including a probe scanning microscope, characterized by comprising:
a computer with a control console, and
a measuring head of the probe scanning microscope, wherein the measuring head comprises a housing, a rough delivery device, an electronics unit and a scanning unit including a scanner, a probe holder and a probe, the housing having dogs, the measuring head having a retaining device, and the rough delivery device having a limit stop to prevent the scanner from possible collision with the examined surface, and the electronics unit having a protective shield for shielding against electromagnetic and other radiation.

7. The apparatus as set forth in claim 6, characterized by further comprising a video camera with lights for visual observation of the examined surface.
